(19) United States
(12) Patent Application Publication
(10) Pub. No.: US 2015/0182419 A1
(43) Pub. Date: Jul. 2, 2015

(54) MECHANICAL DEVICE TO PROVIDE AND ENHANCE EXTERNAL CHEST COMPRESSION FOR CARDIAC RESUSCITATION AND METHOD

(71) Applicant: Randal N. CLOWDUS, Edmond, OK (US)

(72) Inventor: Randal N. CLOWDUS, Edmond, OK (US)

(21) Appl. No.: 14/581,457

(22) Filed: Dec. 23, 2014

Related U.S. Application Data
(60) Provisional application No. 61/964,325, filed on Dec. 31, 2013.

(51) Int. Cl. A61H 31/00

(52) U.S. Cl. CPC A61H 31/004; A61H 31/005

(57) ABSTRACT

A mechanical device for providing external chest compression for cardiac resuscitation, comprising, a first support member positionable horizontally and a second support member positionable vertically, where the first and second support members are rotationally connected together with a swivel attachment that permits the first support member to rotate in an arc with respect to the second support member in at least one of a vertical and horizontal plane for positioning the first support member over a horizontally positioned victim or to maneuver the first support member out of the operative field when not in use, wherein the swivel attachment allows the first support member to be operated in up and down singular strokes in a pumping motion.

### CROSS REFERENCES TO RELATED APPLICATIONS

This application claims the benefit of U.S. Provisional Patent Application No. 61/964,325 filed on Dec. 31, 2013 in the name of Randal N. Clowdus, which is expressly incorporated herein by reference in its entirety.

### BACKGROUND OF THE INVENTION

1. Field of the Invention

This invention relates to emergency cardiac resuscitation. More specifically, the present invention is directed to a hand operated mechanical device to apply pressure impulses to the chest replicating manual procedures used for cardio-pulmonary resuscitation (CPR).

2. Background of the Invention

In the event of cardiac arrest the human body suffers a sudden and complete stoppage of the heart's pumping action. This sudden and fatal cessation of heart function necessitates an immediate intervention of external chest compression known as cardio-pulmonary resuscitation (CPR). CPR is an attempt to restore cardiac pumping to the body in hopes that the heart will either regain its rhythm or sustain blood circulation while emergency personnel administer drugs and other therapeutic modalities to restore the cardiac rhythm. Effective CPR has to be performed at a rate of approximately 100 compressions per minute and at a depth of 1½ to 2 inches of chest compression. This standard of care has been established by the American Heart Association (AHA) as a result of many years of research and clinical trials. Since cardiac arrest can occur anytime and anywhere, providing safe and effective CPR is difficult. One or two man rescue CPR has to be provided to the victim by the “rescuer” kneeling down beside the victim and reaching over the chest area to administer chest compression applied using the heal of the rescuer's hand. This position is not always easy to accomplish due to restricted space and often necessitates that the victim be moved to an area more suitable for CPR which may delay the performance of CPR. Improper performance of CPR often results in the victim suffering broken ribs, punctured lungs, and even death.

Published studies have documented the shortcomings and difficulties of performing manual CPR (e.g., Aufderheide T P, Pirrallo R G, Yannopoulos D, Klein J P, von C, Sparks C W, Deja K A, Kitscha D J, Provo T A, Lurie K G: Incomplete chest wall decompression: a clinical evaluation of CPR performance by trained laypersons and an assessment of alternative manual chest compression-decompression techniques. Resuscitation 2006, 71:341-351). To address these shortcomings and difficulties, a variety of power driven mechanical chest compression devices have become available that provide improved outcomes over manual CPR. However, these devices may be too heavy, expensive (e.g. LUCAS—$15,000), or unsuitable to use in many situations, including those situations where an adequate source of power must also be transported or other therapeutic modalities would be impeded or prevented.

To address the shortcomings of power driven mechanical chest compression devices, as well as those associated with performing manual CPR, hand operated mechanical devices have been proposed including External cardiac massage apparatus (B. RENTSCH, U.S. Pat. No. 3,219,031) and External cardiac compression device (R. EVERETE, U.S. Pat. No. 5,257,619). In some situations, these hand operated devices provide advantages over powered chest compression devices, but also suffer a range of shortcomings in various applications. Shortcomings of these hand operated designs include ease of use, portability, effectiveness, potential for user error, adaptability to victim physiology, and impediments to other therapeutic intervention. Many of the forgoing shortcomings of manual devices are shared with power driven CPR devices in situations critical for survival of a victim.

One such critical situation commonly arises in a Cardiac Catheterization Lab or Interventional Radiology Department clinical setting. Each comprises a setting specializing in procedures that involve active radiological fluoroscopy images to visualize the heart and vessels and chambers in order to provide interventional therapy to correct or improve cardiac disease. If CPR is needed then the hands of the rescue provider or the aforementioned manual and powered mechanical devices performing CPR obscure the fluoroscopic image view of the physician or other attending healthcare practitioner providing emergency intervention. Thus, a device is needed that is radiolucent to avoid image view obstruction, light weight, longitudinally ridged, rapidly deployable, and easily used to perform uninterrupted CPR while physicians or other attending healthcare practitioners are administering life saving interventional therapy.

### SUMMARY OF THE INVENTION

In a first broad aspect, the present invention comprises a first support member positionable horizontally and a second support member positionable vertically where the first and second support members are rotationally connected together with a swivel attachment that permits the first support member to rotate in an arc with respect to the second support member in at least one of a vertical and horizontal plane for positioning the first support member over a horizontally positioned victim or to maneuver the first support member out of the operative field when not in use. The swivel attachment allows the first support member to be operated in up and down singular strokes (pumping action). Positionable on the first support member is a third support member that may be oriented in a position substantially perpendicular to the first support member. The third support member is configured with a rotational connector on one end and a pressure pad on the opposite distal end to impart chest compression in a victim responsive to vertical movement of the first support member.

In one aspect, the third support member provides vertical space between the victim's chest surface and the first support member when positioned horizontally over a victim so that during compression down strokes, depression of the sternum is accomplished without the first support member coming into contact with the chest surface.

In another aspect, a center portion of the first support member may be offset from the end portions to provide additional vertical space between the end portions of the first support member and the victim's chest surface.

In another aspect, the pressure pad on the distal end of the third support member may be configured with a relatively soft plate that mimics the heel portion of a human hand when making direct contact with the victim's sternal area during CPR.

In another aspect, the third support member is slideably and lockably connected to the first support member to allow repositioning for variable and secure centering of the third support member over the victim's chest.

In another aspect, the second support member has a “C” shaped clamp at the distal end permitting attachment to a table or bed frame.

In another aspect, a slide connector may be incorporated in the “C” clamp engaging the second support member and allowing up and down repositioning relative to the clamp to aide in maintaining the first support member in a substantially level position.

In another aspect, the swivel attachment may include a slideably adjustable and lockable connector engaging the second support member for repositioning the swivel attachment vertically on the second support member.

In another aspect, the first support member may be operably extensible over the chest (mid sternal area) of a victim, when the second support member is attached to a table or bed frame on which the victim is horizontally positioned.

In another aspect, the first support member may be extended and the second support member may be adjusted for height until the first support member is substantially level and the soft plate makes contact with the victim's sternum.

In another aspect, the first support member may incorporate a level indicator.

In another aspect, the swivel attachment may incorporate a depth gauge to assist in maintaining proper compression depth during performance of CPR.

In another aspect, the gauge may comprise a dial positioned at the swivel attachment, including an indicator needle that measures the vertical distance travelled by the first support member and converts that measurement to inches of depth delivered to the victim's chest during compressions.

In another aspect, the gauge or swivel attachment may incorporate a positive stop for limiting downward movement of the first support member from a level position.

In another aspect, once the first support member is positioned above the victim and relative level has been established, the gauge may be set at zero and the needle will move with each compression to indicate the depth/distance travelled by the first support member and concomitantly, the soft plate.

In another aspect, the first, second and third support members, the pressure pad, and the soft plate may be constructed of radiolucent material that permits radiological rays to travel through them without substantially obstructing the visual image needed by the radiology provider and other healthcare practitioners for performance of therapeutic intervention.

In another aspect, the first and third support members, the pressure pad, and the soft plate may be constructed of radiolucent material that permits radiological rays to travel through them without substantially obstructing the visual image needed by the radiology provider for and other healthcare practitioners performance of therapeutic intervention.

In another aspect, the center portion of the first support member, the third support member, the pressure pad, and the soft plate may be constructed of radiolucent material that permits radiological rays to travel through them without substantially obstructing the visual image needed by the radiology provider and other healthcare practitioners for performance of therapeutic intervention.

In another aspect, the first, second and third support members may comprise elongated structures configured with any cross-sectional shape determined to maximize their strength and radiolucent properties given the characteristics of the specific material used in their manufacture.

In another aspect, the first, second and third support members may comprise lattice structures adapted to align load plane geometries that reinforce contoured shapes to provide substantial rigidity along a longitudinal axis.

In another aspect, electronic sensors may be applied to the victim's chest to monitor and diagnose cardiac arrhythmias, identify for the rescuer where to position the third support member and soft plate, and indicate the rate and depth of the compressions applied during vertical downward movement of the first support member.

In another aspect, a distal end of the second support member is positionable in a connector mounted on a fourth support member where the second support member is maintained in a relatively vertical orientation when the fourth support member is positioned on a relatively horizontal surface.

In another aspect, the rescuer may assume a position opposite the second support member and with both hands press downward on the distal end of the first support member, wherein the soft plate in contact with the victim's sternum effects compression of the victim's chest.

In another aspect, the rate and depth of compression may be applied in a method structured in accordance with AHA accepted medical practice and as a substitute for manual hand CPR by a single rescuer.

### BRIEF DESCRIPTION OF THE DRAWINGS

FIG. 1 is a non-limiting diagram of the chest compression device of the present invention mounted on a table using the “C” damp and the pressure pad positioned above a victim.

FIG. 2 is a non-limiting diagram of the chest compression device of the present invention configured in combination with electronic sensors, mounted on a table using the “C” clamp and the pressure pad positioned on the chest of a victim.

FIG. 3 is a non-limiting diagram of a front elevation view of the chest compression device of the present invention mounted on a fourth support member configured for use on a flat surface, and the pressure pad positioned above a victim.

FIG. 4 is a non-limiting diagram of a front elevation view of the chest compression device of the present invention with an enlarged view of a camlock lever and pin assembly that allows quick release so that the third support member can slide along the first support member for variable positioning.

FIG. 5 is a non-limiting diagram of a top elevation view and edge view of the fourth support member of the chest compression device of the present invention, the fourth support member adapted for use on a flat surface.

FIG. 6 is a non-limiting diagram showing components of the present invention positioned with wall mounting elements.

### DETAILED DESCRIPTION OF THE INVENTION

The present invention comprises a first support member positionable horizontally and a second support member positionable vertically where the first and second support members are rotationally connected together with a swivel attachment that permits the first support member to rotate in an arc with respect to the second support member in at least one of a vertical and horizontal plane for positioning the first support member over a horizontally positioned victim or to maneuver the first support member out of the operative field when not in use. The swivel attachment allows the first support member to be operated in up and down singular strokes (pumping action) and may be configured with a gage to measure chest compression depth. Positionable on the first support member is a third support member that may be oriented in a position substantially perpendicular to the first support member. The third support member is configured with a rotational connector on one end and a pressure pad configurable with a relatively soft engagement plate on the opposite distal end to impart chest compression in a victim responsive to vertical movement of the first support member. The third support member provides vertical space between the victim's chest surface and the first support member when the first support member is positioned horizontally over a victim so that during compression down strokes depression of the sternum is accomplished without the first support member coming into contact with the chest surface. A center portion of the first support member may be offset from the end portions to provide additional vertical space between the end portions of the first support member and the victim's chest surface. Any combination of the first, second and third support members, and the pressure pad and engagement plate may be constructed of radiolucent material in appropriate cross-sectional shapes as needed to maximize radiolucent properties and allow radiological rays to travel through them without substantially obstructing the visual image needed by the radiology provider and performance of therapeutic intervention. In some applications and operating environments where radiography is not required or available, the support members comprising an embodiment of the present invention may be fabricated from materials that lack or substantially lack radiolucent properties.

The following detailed description of exemplary embodiments of the invention makes reference to the accompanying Figures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the following detailed description is presented for purposes of illustration only and not of limitation.

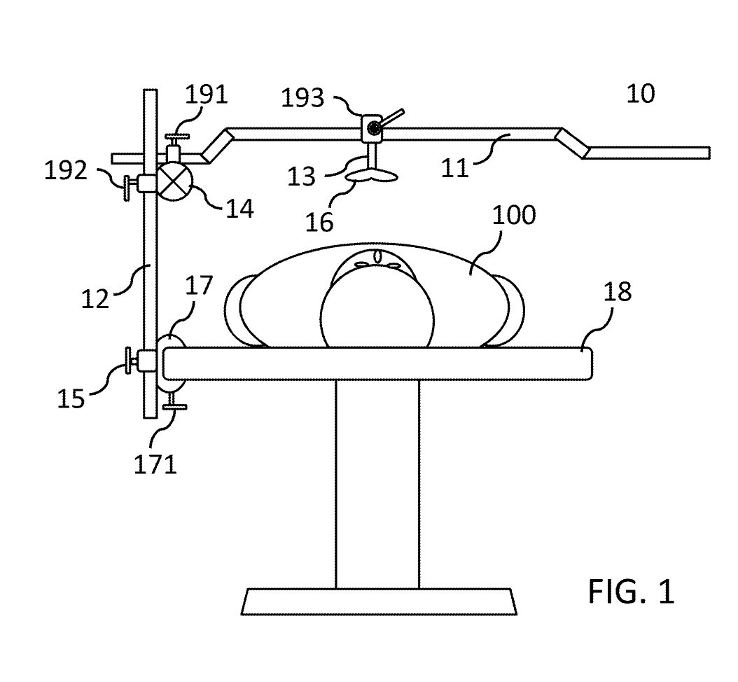

In detail; referring to FIG. 1, the present invention 10 is shown with the first 11, second 12, and third 13 support members configured as elongated, cylindrical structures which may be constructed of a synthetic material that is light weight, providing relatively smooth surfaces, radiolucent material and durable construction; for example a synthetic radiolucent material such as carbon fiber (e.g., T300) in combination with a high-performance polymer such as polyaryletherketone. Pultruded carbon tubes may be used to obtain especially stiff support members 11, 12, and 13. Pultruded carbon tubes are created by pulling linearly-oriented carbon fibers through a resin bath and then a series of tooling to create the specified inner and outer diameters of the tube. The carbon tube is then heated to cure it. This process produces a longitudinally stiff structure due to the unidirectional orientation of the carbon fibers within the tube. The first 11, second 12 and third 13 support members may comprise elongated structures configured with any cross-sectional shape determined to maximize their strength and radiolucent properties given the characteristics of the specific material used in their manufacture. The elongated structures may be fabricated as mesh or lattice structures using additive manufacturing techniques such as those employed by Paramount Industries, Inc. to produce Conformal Lattice Structures (CLS™). In some implementations, such structures have been found to provide superior strength over solid or hollow tube components.

As shown in FIG. 1, the first support member 11 may be configured in a fixed length between 36 inches and 60 inches, with a 40 inch length being sufficient for most applications.

The distal end of the first support 11 member may be configured with approximately a 2 to 4 inch up turn 10 to 14 inches from the end and another approximately 2 to 4 inch down turn 5 to 10 inches from the swivel connection with the second support member. The third support member 13 is shown slidably attached and positioned substantially perpendicular to the first support member 11. The third support member 13 may be sized between approximately 3 inches and 5 inches in length, with a 3 inch length being appropriate for most applications depending on the relative length of any upturn and down turn configured in the first support member. The second support member 12 is shown slidably connected to a “C” clamp 17 using a camlock lever and pin assembly 15; although other types of securing connectors are anticipated. The second support member 12 may be in the range of approximately 15 inches and 40 inches in length with height of the first member 11 being positionable on the second member 12 at least 16 inches above a table 18 surface.

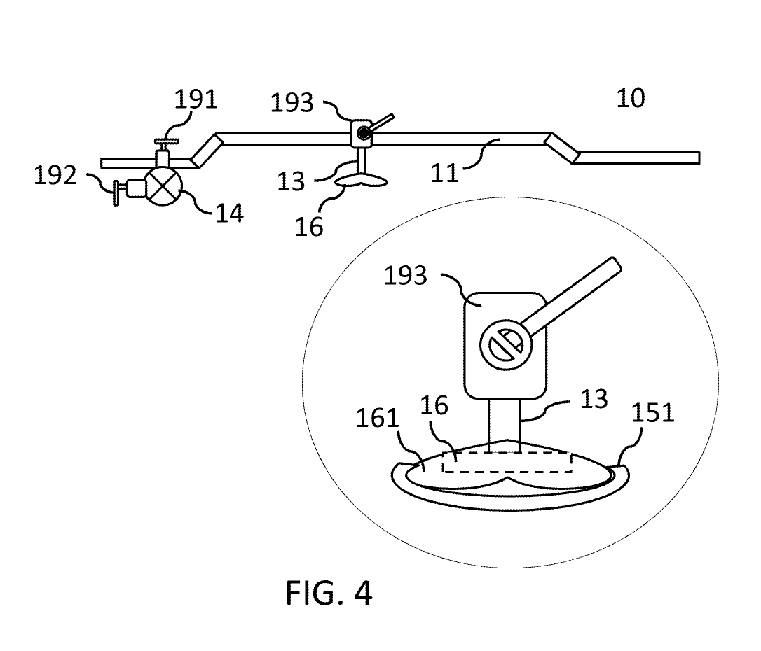

The swivel attachment 14 for connecting the first support member 11 to the second support member 12, as well as any of the support members, may comprise synthetic radiolucent material, such as carbon fiber (e.g., T300) in combination with a high-performance polymer such as polyaryletherketone. The swivel attachment 14 may be slideably connected to the first support member 11 using a camlock lever and pin assembly 191. The swivel attachment 14 may be slideably connected to the second support member 12 using a camlock lever and pin assembly 192. The swivel attachment 14 may be configured to permit the first support member 11 to rotate up to 360 degrees in an arc with respect to the second support member 12 in at least one of a vertical and horizontal plane for positioning the first support member 11 over a horizontally positioned victim 100 or to maneuver the first support member 11 out of the operative field (e.g., not positioned over the victim) when not in use. The third support member 13 is shown attached to the first support member using a camlock lever and pin assembly 193 that allows quick release so that the third support member 13 can slide along the first support member 11 for variable positioning. A pressure pad 16 shown attached to the third support member 13 and further comprising a relatively soft engagement plate (as shown in FIG. 4, 161) and a removable boot (as shown in FIG. 4, 151) that envelopes the pressure pad 16 and engagement plate (FIG. 4, 161) at the distal end of the third support member 13. The engagement plate (FIG. 4, 161) enveloping the pressure pad 16 may be configured as a substantially oval or rectangular rubber material similar in size to the heal of a human hand. The “C” clamp 17 may be a synthetic (e.g., carbon fiber) or metallic material configured with an adjustable fastener 171 on one side of the clamp that secures the “C” clamp 17 to the table 18.

In preferred embodiments, carbon fiber (e.g., T300) in combination with a high-performance polymer such as polyaryletherketone may be used to fabricate support members. The camlock lever and pin assembly 193 may be formed using polyamide (nylon). However, any material exhibiting sufficient radiolucent properties and structural strength may be employed for each specific application and operating environment where the present invention is to be deployed. Additive manufacturing techniques may be used to achieve the desired shapes and cross-sections.

The present invention provides a plurality of adjustments in both height and lateral positions to accommodate most any size patient. Further, if the second support member 12 is positioned adjacent to the victim's left waist area the rescuer operating the device will be positioned at the right shoulder area. lithe second support member 12 is positioned adjacent to the victim's right lateral chest level then the rescuer operating the device will be directly opposite on the left lateral chest area. This clockwise or counterclockwise positioning is highly adaptable for essentially all situations, table configurations, and positions for the rescue team members.

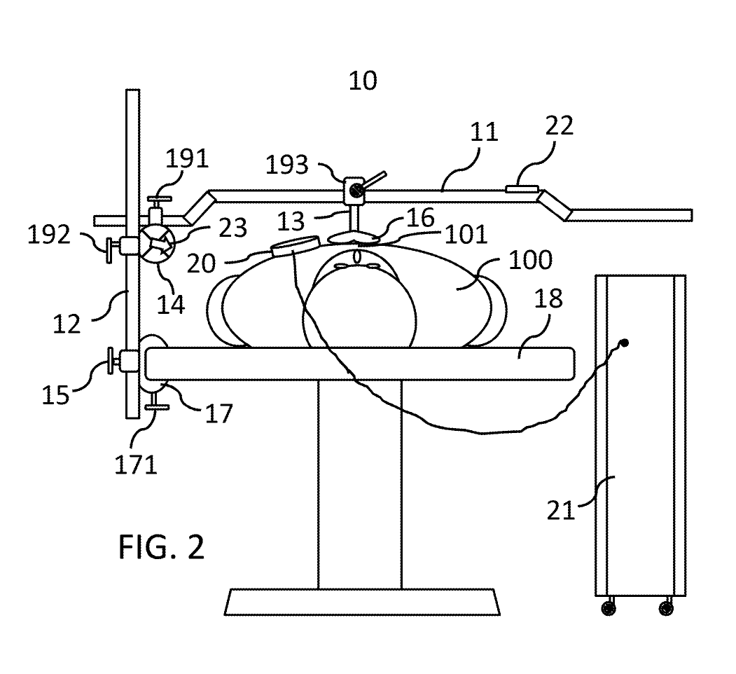

Referring now to FIG. 2, there is shown a non-limiting diagram of the chest compression device of the present invention 10 configured in combination with electronic sensors 20 connected to a monitor 21, and mounted on a table 18 using the “C” damp 17, where the pressure pad (not visible) and engagement plate (FIG. 4, 161) enveloping the pressure pad 16 are positioned on the chest of a victim 100. The first support member 11 may be extended and the second support member 12 may be adjusted for height until the first support member 11 is substantially level, the third support member 13 is positioned over the center of the chest area, and the engagement plate (FIG. 4, 161) mounted on the pressure pad 16 makes contact with the victim's sternum 101. In some embodiments, the first support member 11 may incorporate a level indicator 22 and the swivel attachment 14 may incorporate a depth gauge 23 to assist in maintaining proper compression depth during performance of CPR. The depth gauge 23 may comprise a dial positioned at the swivel attachment 14, including an indicator needle that measures the vertical distance travelled by the first support member 11 and converts that measurement to inches of depth delivered to the victim's chest at the sternum 101 during compressions. The depth gauge 23 or swivel attachment 14 may incorporate a positive stop for limiting downward movement of the first support member 11 from a level position. Once the first support member 11 is positioned above the victim 100 and relative level has been established, the depth gauge 23 may be set at zero and the needle will move with each compression to indicate the depth/distance travelled by the first support member 11 and concomitantly, the engagement plate (FIG. 4, 161) enveloping the pressure pad 16.

In another aspect, the first 11, second 12 and third 13 support members, the pressure pad 16, and the engagement plate (FIG. 4, 161) may be constructed of radiolucent material that permits radiological rays to travel through them without substantially obstructing the visual image needed by the radiology provider and other healthcare practitioners for performance of therapeutic intervention. The desired shapes may be achieved using additive manufacturing.

In another aspect, the first 11 and third 13 support members, the engagement plate (FIG. 4, 161) and the pressure pad 16 may be constructed of radiolucent material that permits radiological rays to travel through them without substantially obstructing the visual image needed for performance of therapeutic intervention by the radiology provider and other healthcare practitioners.

In another aspect, the center portion of the first support member 11 substantially between the upturn and down turn shown, the third support member 13, the pressure pad 16, and the engagement plate (FIG. 4, 161) may be constructed of radiolucent material that permits radiological rays to travel through them without substantially obstructing the visual image needed by the radiology provider and other healthcare practitioners for performance of therapeutic intervention.

In another aspect, the first 11, second 12, and third 13 support members may comprise lattice structures adapted to align load plane geometries that reinforce contoured shapes to provide substantial rigidity along a longitudinal axis. The lattice structures may be formed using additive manufacturing techniques to create elongated shapes resistant to bending under load during use in performing CPR. The lattice structures may be formed using durable polyamide (nylon) and other radiolucent material exhibiting a Tensile Modulus at or above 1700 MPa and a Flexural Modulus at or above 800 MPa.

In another aspect, electronic sensors 20 may be applied to the chest area of the victim 100 to monitor and diagnose cardiac arrhythmias, identify for the rescuer where to position the third support member 13 and engagement plate (FIG. 4, 161) enveloping the pressure pad 16, and indicate the rate and depth of the compressions applied during vertical downward movement of the first support member 11. The rescuer may assume a position opposite the second support member 12 and with both hands press downward on the distal end of the first support member 11, wherein the engagement plate (FIG. 4, 161) enveloping the pressure pad 16 in contact with the victim's sternum 101 effects compression of the victim's chest.

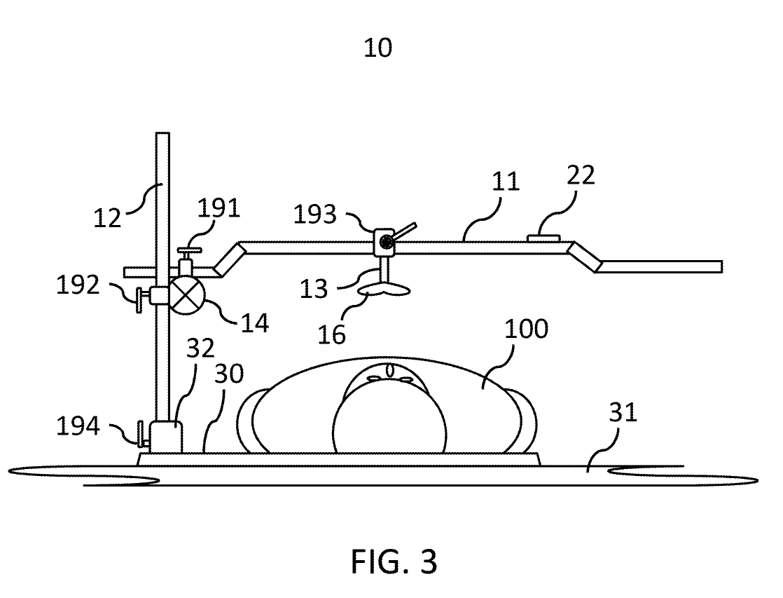

Referring now to FIG. 3 there is shown a non-limiting diagram of front elevation view of the chest compression device of the present invention 10 mounted on a fourth support member 30 configured for use on a flat surface 31, and the engagement plate (FIG. 4, 161) enveloping the pressure pad 16 are positioned above a victim 100. A distal end of the second support member 12 is positionable in a connector 32 mounted on the fourth support member 30 where the second support member 12 is received and maintained in a relatively vertical orientation when the fourth support member 30 is positioned on a relatively horizontal surface 31. The distal end of the second support member 12 is shown held in place by a camlock lever and pin assembly 194. The first 11, second 12 and third 13 support members may comprise elongated structures configured with any cross-sectional shape determined to maximize their strength and radiolucent properties given the characteristics of the specific material used in their manufacture. The first 11, second 12, and third 13 support members may further comprise lattice structures adapted to align load plane geometries that reinforce contoured shapes to provide substantial rigidity along a longitudinal axis. The lattice structures may be formed using additive manufacturing techniques to create elongated shapes resistant to bending under load during use in performing CPR. The lattice structures may be formed using durable polyamide (nylon) and other radiolucent material exhibiting a Tensile Modulus at or above 1700 MPa and a Flexural Modulus at or above 800 MPa. The camlock lever and pin assembly 193 may be formed using polyamide (nylon) and additive manufacturing techniques.

Referring to FIG. 4, a non-limiting diagram of a front elevation view of the chest compression device of the present invention 10 is shown with an enlarged view of a camlock lever and pin assembly 193 that allows quick release so that the third support member 13 can slide along the first support member 11 for variable positioning. The pressure pad 16 is shown enveloped by the engagement plate 161 and the removable boot 151. The removable boot 151 may be disposable for sanitary purposes, and may comprise radiolucent material.

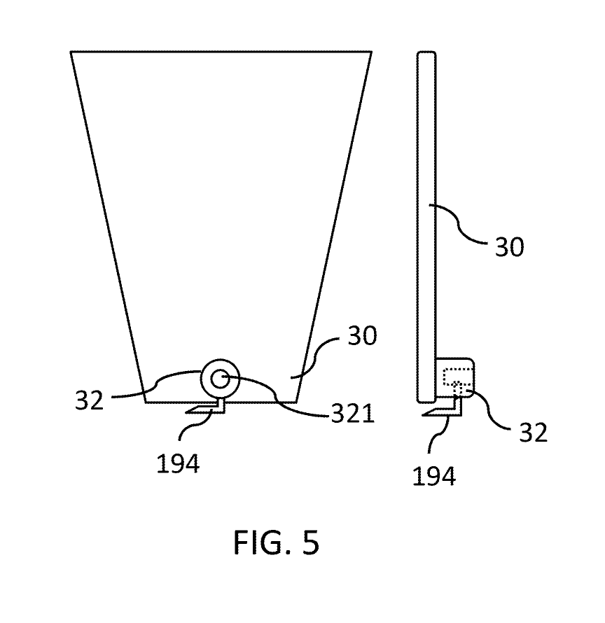

Referring to FIG. 5, a non-limiting diagram of a top elevation view and edge view of the fourth support member 30 of the chest compression device of the present invention 10 is shown and further depicting a camlock lever and pin assembly 194. A distal end of a second support member (FIG. 3, 12) is positionable in a connector 32 mounted on the fourth support member 30, where a distal end of the second support member (FIG. 3, 12) is received in the connector 32 by inserting into an opening 321 in the connector 32, where the second support member (FIG. 3, 12) is maintained in a relatively vertical orientation when the fourth support member 30 is positioned on a relatively horizontal surface (FIG. 3, 31).

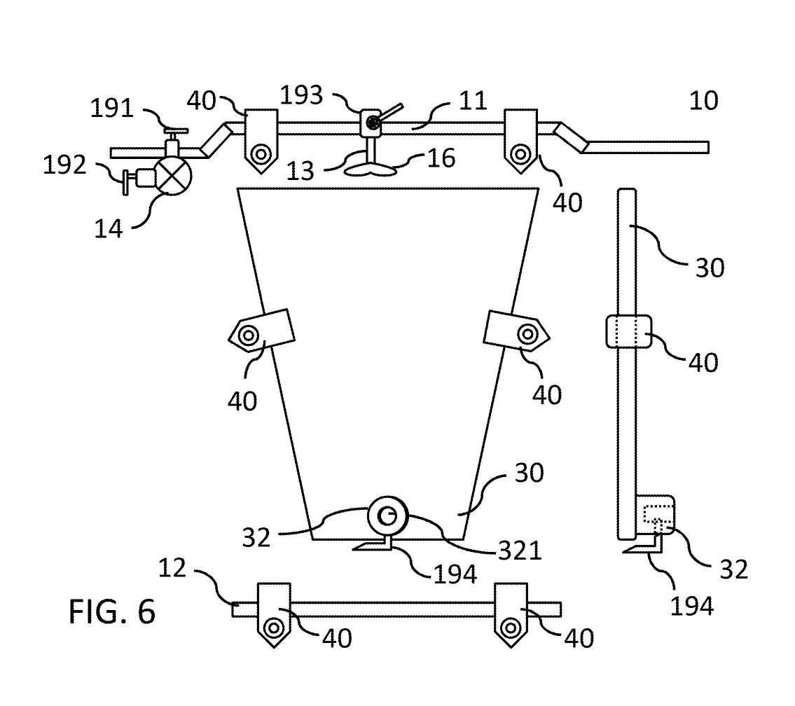

Referring now to FIG. 6, a non-limiting diagram shows components of the present invention 10 positioned with wail mounting elements 40. The present invention 10 is designed to for easy application and may be placed in a partially disassembled state in wall mounted brackets 40 for rapid assess. Since it does not require any external power source, it can be placed in a plurality of locations for stowage and use absent the presence of an electric power source. The present invention 10 can be placed in mounting brackets 40 installed on a wall for easy visibility, and placed near emergency equipment for easy accessibility. The present invention 10 can be positioned with Emergency Automated Defibrillators (EAD). These are becoming more and more common in public places and the present invention 10 can be positioned along side of the EADs for a dual purpose of enhancing CPR and decreasing ambiguity as stated by the AHA guidelines. “Pictograms” can be mounted with the components of the present invention 10 to aid in the application of service by lay persons. About 92% of sudden cardiac arrest victims die before reaching the hospital, but statistics prove that if more people were able to administer CPR for sufficient periods of time more lives could be saved. Immediate CPR can double, or even triple, a victim's chance of survival.

The rate and depth of compression affected using the present invention 10 may be applied in a method structured in accordance with AHA accepted medical practice and as a substitute for manual hand CPR by a single rescuer. There are five critical components of high-quality CPR: minimize interruptions in chest compressions, provide compressions of adequate rate and depth, avoid leaning between compressions, and avoid excessive ventilation. Recognition of these components was published in an AHA Consensus Statement dated Jun. 25, 2013. The AHA Consensus Statement also recited that victims often do not receive high-quality CPR because of provider ambiguity in prioritization of resuscitative efforts during an arrest. This ambiguity also impedes the development of optimal systems of care to increase survival from cardiac arrest. Clear definitions of metrics and methods to consistently deliver and improve the quality of CPR will narrow the gap between resuscitation science and the victims both in and out of the hospital and lay the foundations for further improvement in the future.

In all the publications provided by the AHA the amount of foot pounds of pressure are not addressed. This unit of measurement is not significant. The only measure that is significant is the depth of compression. This depth is essential in order to squeeze the ventricles of the heart in order to eject the blood thru the vascular system. The amount of pounds of pressure is only relevant to the size of the victim or the strength of the rescuer. If the victim is large in size, CPR will necessitate more force. If the rescuer is small in stature, then it will take more effort to perform CPR. In any event, rate and depth are still the primary goals of effective CPR. The present invention addresses this issue by utilizing the physics of leverage and fulcrum. The length of the first support member 11 allows the rescuer to deliver more pressure with less effort thus reducing the amount of physical exertion needed to compress the chest the necessary 1½ to 2 inches as required by the AHA standard.

In addition to the ability of the present invention 10 to deliver adequate CPR rate and depth is the advent of electronic sensors 20 in portable ECG monitor/defibrillator units now in service on most Advanced Life Support Ambulances and Fire Rescue Units. These new sensors 20 are part of the ECG electrodes applied to the victim's chest to monitor and diagnosis cardiac arrhythmias. When patches are applied correctly it tells the rescuer where to place the heel of the hand for CPR and calls out the rate and depth of the compressions. The present invention 10 can be positioned on the electronic sensor 20 just like a rescuer's hand would be placed when the sensor 20 is positioned over the sternal area. The compressions can be given at the rate and depth that the sensor 20 and monitor 21 dictate. This efficacy will enhance compressions and meet the standard of AHA care.

The present invention 10 is light weight so when downward pressure is released there is not significant pressure left on the chest of the victim 100. This prevents “leaning” as described by the AHA's guidelines. Leaning occurs when a rescuer does not completely relax at the end of the downward stroke of CPR. As a rescuer performs CPR for any extended period of time, they naturally become fatigued and tend not to completely release pressure on the chest between compressions. The present invention 10 addresses this problem by minimizing resistance to the hinge action of the first support member 11. When pressure is released by the rescuer, the first support member 11 relaxes with the natural relaxation of the chest wall, thereby, preventing leaning.

1. A mechanical device for providing external chest compression for cardiac resuscitation, comprising: a first support member positionable horizontally and a second support member positionable vertically, the first and second support members rotationally connected together with a swivel attachment that permits the first support member to rotate in an arc with respect to the second support member in at least one of a vertical and horizontal plane for positioning the first support member over a horizontally positioned victim or to maneuver the first support member out of an operative field when not in use, wherein the swivel attachment is adapted to allow the first support member to be operated in up and down singular strokes (pumping action), and wherein a center portion of the first support member is adapted for offset from the end portions to provide additional vertical space between the end portions of the first support member and the victim's chest surface.

2. The mechanical device of claim 1, wherein a third support member is positionable on the first support member oriented in a position substantially perpendicular to the first support member.

3. The mechanical device of claim 2, wherein the third support member is configured with a rotational connector on one end and a pressure pad on the opposite distal end to impart chest compression in a victim responsive to vertical movement of the first support member.

4. The mechanical device of claim 3, wherein the third support member provides vertical space between the victim's chest surface and the first support member when positioned horizontally over a victim, so that during compression down strokes, depression of the sternum is accomplished without the first support member coming into contact with the chest surface.

5. The mechanical device of claim 3, wherein the pressure pad on the distal end of the third support member may be configured with a relatively soft engagement plate that mimics the heel portion of a human hand when making direct contact with the victim's sternal area during CPR.

6. The mechanical device of claim 3, wherein the third support member is slideably and lockably connected to the first support member to allow repositioning for variable and secure centering of the third support member over the victim's chest.

7. In another aspect, the second support member has a “C” shaped clamp at the distal end permitting attachment to a table or bed frame, and a slide connector may be incorporated in the “C” clamp engaging the second support member, allowing up and down repositioning relative to the clamp to aide in maintaining the first support member in a substantially level position.

8. The mechanical device of claim 1, wherein the swivel attachment may include a slideably adjustable and lockable connector engaging the second support member for repositioning the swivel attachment vertically on the second support member.

9. The mechanical device of claim 1, wherein the first support member may be extensible over the chest (mid sternal area) of a victim when the second support member is attached to a table or bed frame on which the victim is horizontally positioned.

10. The mechanical device of claim 1, wherein the first support member may be extended and the second support member may be adjusted for height until the first support member is substantially level and the soft engagement plate makes contact with the victim's sternum.

11. The mechanical device of claim 1, wherein the first support member may incorporate a level indicator, and the swivel attachment may incorporate a depth gauge to assist in maintaining proper compression depth during performance of CPR.

12. The mechanical device of claim 11, wherein the gauge may comprise a dial positioned at the swivel attachment, including an indicator needle that measures the vertical distance travelled by the first support member and converts that measurement to inches of depth delivered to the victim's chest during compressions.

13. The mechanical device of claim 12, wherein the gauge or swivel attachment may incorporate a positive stop for limiting downward movement of the first support member from a level position.

14. The mechanical device of claim 13, wherein once the first support member is positioned above the victim and relative level has been established, the gauge may be set at zero and the needle will move with each compression to indicate the depth/distance travelled by the first support member and concomitantly, the soft engagement plate.

15. The mechanical device of claim 1, wherein at least one of the first, second and third support members, the pressure pad, and the soft engagement plate is constructed of radiolucent material that permits radiological rays to travel through them without substantially obstructing the visual image needed by the radiology provider and other healthcare practitioners for performance of therapeutic intervention

16. The mechanical device of claim 1, wherein the center portion of the first support member, the third support member, the pressure pad, and the soft engagement plate may be constructed of radiolucent material that permits radiological rays to travel through them without substantially obstructing the visual image needed by the radiology provider and other healthcare practitioners for performance of therapeutic intervention.

17. The mechanical device of claim 1, wherein the first, second and third support members comprise elongated structures in any combination, solid or hollow, configured with any cross-sectional shape or lattice structure determined to maximize their strength and radiolucent properties given the characteristics of the specific material used in their manufacture.

18. The mechanical device of claim 1, wherein a distal end of the second support member is positionable in a connector mounted on a fourth support member where the second support member is maintained in a relatively vertical orientation when the fourth support member is positioned on a relatively horizontal surface.

19. A method of using a mechanical device by an operator to provide external chest compression for cardiac resuscitation, comprising:
providing said mechanical device including at least a first support member positionable horizontally, a second support member positionable vertically and a third support member positionable on the first support member, the first and second support members rotationally connected together with a swivel attachment that permits the first support member to rotate in an arc with respect to the second support member in at least one of a vertical and horizontal plane, and the third support member oriented in a position substantially perpendicular to the first support member;
positioning the first support member over a horizontally positioned victim;
assuming a position opposite the second support member and with both hands press downward on the distal end of the first support member, wherein a soft engagement plate in contact with the victim's sternum effects compression of the victim's chest;
wherein the rate and depth of compression can be applied in a method structured in accordance with AHA accepted medical practice and as a substitute for manual hand CPR by a single rescuer;
wherein the swivel attachment is adapted to allow the first support member to be operated in up and down singular strokes (pumping action), and
wherein a center portion of the first support member is adapted for offset from the end portions to provide additional vertical space between the end portions of the first support member and the victim's chest surface.

20. The method of claim 19, wherein electronic sensors are applied to the victim's chest to monitor and diagnose cardiac arrhythmias, to identify for the rescuer the placement position of the third support member and soft engagement plate, and indicate the rate and depth of the compressions applied during vertical downward movement of the first support member.
